(19) United States
(12) Patent Application Publication
(10) Pub. No.: US 2008/0191838 A1
(43) Pub. Date: Aug. 14, 2008

(54) Biometric Protection of a Protected Object

(75) Inventors: Srinivas Venkata Rama Gutta, Bangalore (IN); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/908,844

(22) PCT Filed: Mar. 14, 2006
(86) PCT No.: PCT/IB06/50795

§ 371 Date: Sep. 17, 2007

Related U.S. Application Data
(60) Provisional application No. 60/663,124, filed on Mar. 18, 2005.

(51) Int. Cl. G06K 9/00

(52) U.S. Cl. 340/5.53; 340/5.52

(57) ABSTRACT

Multiple biometric samples (180) of an authorized user are associated with protected material (170), and access (250) to protected material (170) is based on a comparison of a sample (210) of a biometric to these multiple protection-samples (180) of the biometric. The likelihood of wrongly-denying access to the material is controlled by the criteria used in the comparison (240) of the access-sample to each protection-sample. The likelihood of wrongly-allowing access to the material is controlled by the criteria used to grant access (370) based on the multiple comparisons. To further control the likelihood of wrongly-allowing access to the material, multiple biometric samples (210) are collected during the access-granting period, and these multiple access-samples (210) are compared to the multiple protection-samples (180).

This invention relates to the field of consumer electronics, and in particular to a system for the protection of an object based on biometric samples.

Biometric measures have been proposed to control access to protected objects, such as protected locations and protected content material. Typically, a biometric feature is sensed or sampled by a sensing device and parameters associated with the sample are compared with parameters associated with other samples of the biometric feature. For ease of reference, the term biometric or biometric measure is used hereinafter to refer to the parameters associated with a sensed or sampled biometric feature. Thus, for example, the term ‘fingerprint’ includes whatever parameters are typically derived from an image of a person's finger tip.

In an example biometric security system for protecting protected content material, a purchaser's fingerprint is used to generate a symmetric key that is used to encrypt the content material when it is purchased. In such a system, the receiving device is configured to similarly generate a key to decrypt the protected object, based on the user's fingerprint when the user attempts to render the material. In principle, if the same finger is used to create the encryption key and the decryption key, then the decryption key will match the encryption key, and the encrypted material will be properly decrypted at the receiving device.

In another example biometric security system, a purchaser's fingerprint (or other biometric feature) is encoded into a watermark that is embedded in the purchased copy of the protected object. The receiving system decodes the watermark and compares the purchaser's fingerprint with the user's fingerprint, and subsequently renders the protected material only if the fingerprints match.

In other example biometric security systems, access to a building or other resource is controlled by scanning a biometric of each person attempting to access the protected resource, and comparing this biometric to a database containing a sample of the biometric from each person authorized to access the building or resource.

It is well known, however, that biometrics change with time, and each reading of a biometric may differ based on the particular device used, the orientation of the biometric feature relative to the sensing device, the level of interference between the biometric feature and the sensing device, the clarity of the biometric feature, and so on. As is known in the art of criminal forensics, for example, the variance present in different instances of a person's fingerprint typically requires expert analysis to declare a definitive match.

Because it is known that biometrics may be subject to variations, the use of biometrics for security purposes may exhibit a high occurrence of “false negatives”, wherein an authorized user is erroneously prohibited access to the protected object. The conventional cure for a high occurrence of wrongly-denied-access errors is to modify the test criteria so as to create a less-restrictive test.

For example, Uludag et al. in “MULTIMEDIA CONTENT PROTECTION VIA BIOMETRICS-BASED ENCRYPTION”, at the IEEE ICME 2003 conference, teaches a system wherein a biometric, such as a fingerprint, is used as a key to encrypt content material. However, because a later-sampled biometric of the same person will not “exactly” match the original biometric used to create the encrypting key, and thus will not produce a matching decrypting key, a copy of the original biometric is included with the encrypted material, so that this original biometric can be used to create the decrypting key. When a user desires access to the encrypted material, the user's biometric is compared to the copy of the original biometric, and if this comparison-test is passed, the decrypting key is created from the copy of the original biometric, and the material is decrypted for use by the user. Although not expressly stated, the comparison-test used in Uludag et al. to compare the user's biometric to the copy of the original fingerprint presumably does not require the exact-match that is required by the encryption scheme, because it is designed to avoid the false-negatives caused by the need for an exact biometric match in the encryption system.

As is well known in the art, however, reducing the security of a protection scheme to avoid wrongly-denying-access (false-negatives) errors, necessarily introduces a higher occurrence of wrongly-granting-access (false-positives) errors, wherein unauthorized users are erroneously allowed access to the protected object.

Vendors of protected content material are sensitive to both wrongly-denying and wrongly-granting errors. Purchasers who are subjected to wrongful denials will be reluctant to make future purchases from that vendor. Conversely, wrongful grants deny the vendor of deserved revenue. Vendors are also particularly sensitive to the loss of long-time repeat customers, and are thus particularly sensitive to wrongful denials to such customers.

It is an object of this invention to provide a protection system for protected objects that is viable despite the variance of biometric measures. It is a further object of this invention to provide a biometric-based protection system for protected objects that provides a suitable balance between wrongly-denying and wrongly-granting errors. It is a further object of this invention to provide a biometric-based protection system that reduces the likelihood of wrongly-denying access to repeat customers.

These objects, and others, are achieved by a method and system wherein multiple biometric samples of an authorized user are associated with a protected object, and access to protected object is based on a comparison of a sample of a biometric to these multiple protection-samples of the biometric. The likelihood of wrongly-denying access to the object is controlled by the criteria used in the comparison of the access-sample to each protection-sample. The likelihood of wrongly-allowing access to the object is controlled by the criteria used to grant access based on the multiple comparisons. To further control the likelihood of wrongly-allowing access to the object, multiple biometric samples are collected during the access-granting period, and these multiple access-samples are compared to the multiple protection-samples.

The invention is explained in further detail, and by way of example, with reference to the accompanying drawings wherein:

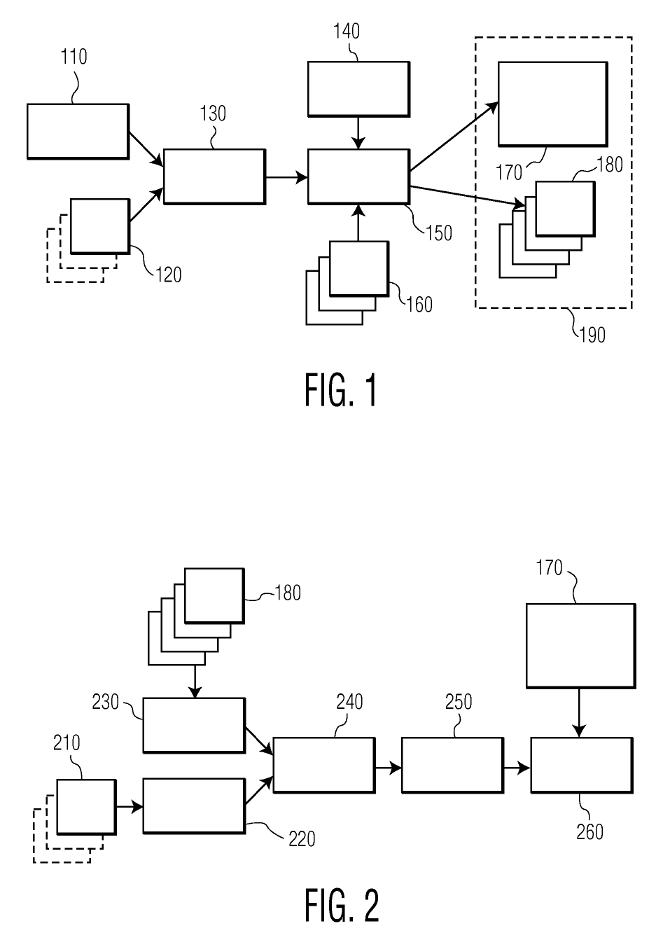

FIG. 1 illustrates an example block diagram of a content-protection system in accordance with this invention.

FIG. 2 illustrates an example block diagram of an access-control system in accordance with this invention.

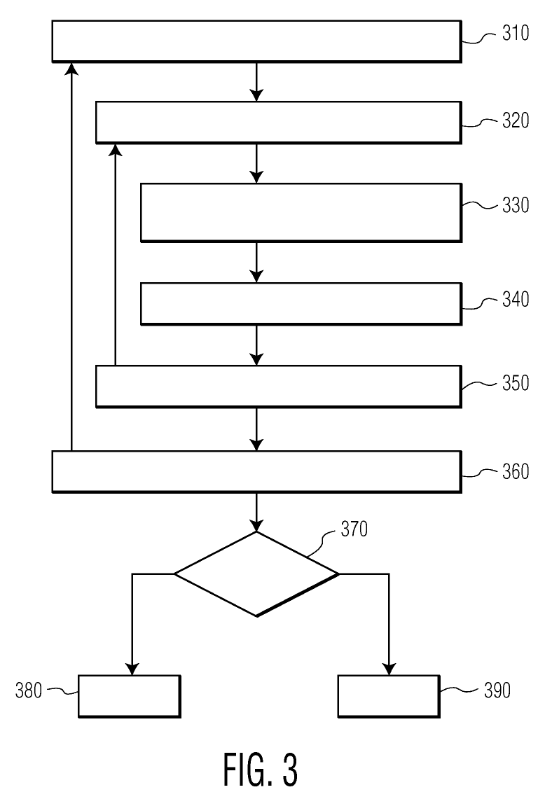

FIG. 3 illustrates an example flow diagram of an access-control system in accordance with this invention.

Throughout the drawings, the same reference numeral refers to the same element, or an element that performs substantially the same function. The drawings are included for illustrative purposes and are not intended to limit the scope of the invention.

In accordance with this invention, a sample biometric is compared to a plurality of samples of the biometric, and access to the protected object is granted based on a composite result from these multiple tests.

In all less-than-exact tests, there is a finite probability that two biometrics from the same person will fail a comparison test, and that there is another probability that two biometrics from different people will pass the comparison test. Both of these probabilities are a function of the criteria used for the comparison. If the test is very “strict”, the likelihood that biometrics from different people will pass the test decreases, but the likelihood that biometrics from the same person will fail the test increases. If the test is very “loose”, the likelihood that biometrics from the same person will fail the test decreases, but the likelihood that biometrics from different people will pass the test increases.

If N different comparisons are available, and a test is defined based on the composite results of these N individual tests, the likelihoods of the biometrics of the same person failing the composite test, or the biometrics of different people passing the test, can be controlled by the criteria used in the composite test, rather than the criteria used in the individual comparison tests. Consider, for example, N independent tests, wherein the probability of two biometrics of the same person failing each test is p1. If the test criteria is that at least one of the comparison tests must be passed for the composite test to pass, the probability of the biometrics of the same person failing the composite test is (p1)^{N}, which can be substantially less than p1. If the test criteria is that all of the comparison tests must be passed for the composite test to pass, the probability of the biometrics of the same person failing the composite test is 1−(1−p1)^{N}, which can be substantially greater than p1. In like manner, if the probability of the biometrics of different people matching is p2, the probability of at least one of N multiple tests providing a match is 1−(1−p2)^{N}, which can be substantially greater than p2, and the probability of all of the N multiple tests providing a match is (p2)^{N}, which can be substantially less than p2. Criteria between the above at-least-one test and the every-one test will provide error probabilities between these two extremes. Thus, by controlling the criteria used in the composite test, the probability of errors can be controlled to be greater or less than the probability of errors in the individual tests.

In accordance with this invention, multiple tests for controlling access to a protected object are made available by providing multiple different samples of a biometric of an authorized user. By providing these multiple samples of the biometric, a composite test can be performed based on results of comparisons of a sample of the biometric with each of the multiple samples, and this composite test can be designed to provide a desired balance, or trade-off, between wrongful-denials and wrongful-grants of access to the protected object.

FIG. 1 illustrates an example block diagram of a content-protection system in accordance with this invention. The invention is presented herein using the paradigm of a purchase of content material, but one of ordinary skill in the art will recognize that the principles of this invention are applicable to protection schemes that are not related to purchases, and are not related to content material.

A receiver 130 receives a purchase request 110 and an associated biometric 120 of the purchaser. The purchase request 110 identifies content material 140 that is protected by a security device 150, typically located at a vendor's site. In an example embodiment, the purchaser submits the purchase request 110 at a kiosk that includes a biometric sampler. In an alternative embodiment, the user's home computer, or home entertainment system, is equipped with a biometric sampler, and the user submits the purchase request 110 and biometric sample 120 via an Internet connection to the vendor's receiver 130. Other schemes for coupling a purchase request 110 and a biometric sample 120 are common in the art.

The security device 150 processes the purchase request to provide a protected copy 170 of the content material 140. Techniques for providing protected copies of content material are common in the art. In some techniques, the content material is encrypted, so that the content material cannot be accessed without a proper decryption key. In other techniques, the content material is marked with a security indicator, such as a watermark, and “compliant” rendering devices are configured to prevent the rendering of the material until and unless a security test is passed. The particular security technique employed to protect the content material from unauthorized access is not relevant to this invention, other than that the security technique includes a biometric-based security test that is based on a match of a biometric sample to the biometric of the authorized user, who in this example is the purchaser.

In accordance with this invention, the security device 150 is configured to associate a plurality 180 of samples of the purchaser's biometric to the protected content material 170. For the purposes of this invention, the plural term “samples” is herein defined to mean “different” samples, and not merely copies of a given sample. Because at least a portion of the variance associated with a biometric can be attributed to the variance associated with how the sample is obtained, such as the particular orientation of the biometric being sampled to the machine performing the sampling, each sample is preferably acquired independently.

In the example of a purchaser of content material, the samples of the purchaser's biometric that were obtained for prior purchases serve as exemplary independently acquired samples. In a preferred embodiment of this invention, the vendor stores the purchaser's prior biometric samples 160, and the security device 150 uses these samples 160, as well as the current sample 120, to form the plurality of samples 180 that are associated with the protected content material 180. In other applications, other techniques can be used to obtain independent samples over time, including, for example, in a building-access security system, randomly storing a sample of an employee's biometric when the employee uses the security system to enter the building.

If prior independent samples of the biometric are not available, the system can be configured to obtain multiple samples 120 during the purchase process. Although these samples will not include the long-term contributions to the variance of the biometric, if the receiver 130 is configured to require removal of the biometric from the sampling component between each sample, some variance among the samples 120 will be obtained.

Depending upon the configuration of the access-control system, discussed below, the plurality of samples 180 may be stored with the protected content material, such as on a media 190 that is communicated to the purchaser, or stored independent of the protected content material, such as at a remote location that is accessed by the access-control system as required.

FIG. 2 illustrates an example block diagram of an access-control system in accordance with this invention. Depending upon the particular embodiment of this invention, the illustrated components may be located in a single device at a user's location, or they may be distributed between the user's location and a remote location that is configured to grant or deny access to the protected content material 170. For example, if the content material 170 and biometric samples 180 are provided to a user on a media, such as a CD or DVD, the illustrated components may be contained in a CD or DVD player that is configured to enforce the desired protection. Alternatively, the material 170 and biometric samples 180 may be located at a remote site, such as an Internet site, and some of the components would be located at the remote site for controlling downloading of the material 170. Similarly, the material 170 may be at the user's site, and the protection scheme requires an access authorization from a remote site that contains the samples 180. Other configurations and distributions of components will be evident to one of ordinary skill in the art.

A receiver 230 is configured to provide access to the plurality of biometric samples 180 of an authorized user of protected content material 170, and a reader 220 is configured to provide a sample of a biometric 210 of a user attempting to gain access to the protected content material 170. As noted above, the receiver 230 may be a component of a user's system that receives the samples 180 from a CD or DVD containing the protected content material, or it may be a component at a remote site that accesses a database that contains the samples 180 associate with the protected content material 170. In like manner, the reader 220 may be included in a user's system for sampling the user's biometric, or it may be at the remote site and configured to receive signals transmitted from another component at the user's site.

The reader 220 is preferably configured to verify that the biometric sample 210 is being sampled from a live person, and not from an inanimate copy of the biometric, using techniques common in the art. The reader 220 may also be configured to obtain multiple samples 210 of the biometric of the user, to improve the effectiveness of the testing, and/or to verify that the authorized user is still present while the content material 170 is being rendered. For example, if the content material 170 is a presentation of “confidential” information, the system may be configured to assure that the authorized viewer remains in proximity to the presentation, to prevent the viewing of the material by other, unauthorized viewers.

A comparator 240 is configured to compare the sample 210 to each of the plurality of biometric samples 180, and to provide the results of these comparisons to a tester 250. The tester 250 is configured to perform a composite test, based on the results of the individual comparisons, to determine whether to provide an access authorization to an access device, such as a renderer 260. The renderer 260 is configured to render the protected content material 170, dependent upon access authorization provided by the tester 250. As noted above, the comparator 240 and tester 250 may be located at a user's site that includes the renderer 260, or they may be located at a remote site, with the tester 250 being configured to transmit the access authorization to the renderer 260, via, for example, an Internet connection. The operation of the comparator 240 and tester 250 components is best understood with reference to FIG. 3.

FIG. 3 illustrates an example flow diagram of an access-control system in accordance with this invention. References to items in FIG. 2 are included, for ease of understanding.

The loop 310-360 is repeated for each biometric sample 210, herein termed the “access-biometric”, provided by the reader 220. In an embodiment that provides a single sample 210, this loop is eliminated. The access-biometric is compared to each of the samples 180 that are associated with the protected material 170, herein termed the “protect-biometric”, provided by the receiver 230 in the loop 320-350.

At 330, the access-biometric is compared to the current protect-biometric, using techniques common in the art. The result of the comparison, typically a pass/fail, match/no-match result, is accumulated at 340. Note that although a binary result is commonly provided by conventional biometric-comparators, this invention is not limited to binary comparisons. If the results are binary, the accumulation at 340 is merely a tally of the number of matches, or the number of non-matches; if the results are not binary, the accumulation at 340 may be a recording of the individual results, for subsequent processing, or an accumulation of a sum or an average of the results, or any other accumulation suitable to the form of the reported result. Similarly, the accumulation may be a mix of binary and non-binary factors. For example, the age of each protect-biometric may be used to form a weighted average of the results, wherein a match to a recent sample of a protect-biometric is given more weight than a match to an older sample. These and other methods of accumulating test results to form a composite test result will be evident to one of ordinary skill in the art in view of this disclosure.

At 350, the process is illustrated as looping back to 320 for the next security-biometric, for ease of understanding. One of ordinary skill in the art will recognize that this looping may also be affected by the results of the accumulation at 340 and the defined composite test criteria. For example, if the tester 250 is configured to declare that the test is passed if at least a given threshold number of comparison-matches are achieved, the loop 320-350 can be terminated if the given number of comparison-matches are achieved, even if there are remaining protect-samples that have not yet been compared. In like manner, the loop 320-350 can be terminated if the accumulated number of non-matches makes achieving the requisite threshold of matches impossible.

After 350, the process is illustrated as proceeding to 360 directly, to process another access-biometric via the loop 310-360. Depending upon the particular embodiment, and the particular test employed for multiple access-biometrics, this flow may vary. For example, there may be an intermediate processing of each access-biometric's accumulated results, to determine whether to grant access until the next access-biometric is obtained and evaluated. Or, the composite test may be structured to be dependent upon each access-biometric's accumulated results, rather than a single accumulation of results, as illustrated by the flow of FIG. 3.

At 370, the accumulated results of the comparisons of the access-biometric to the plurality of protect-biometrics are assessed to determine a composite test result. In a straightforward embodiment of this invention, the accumulated results are compared to a threshold value; and, if the results fall below the threshold, the composite test returns an access-denied result at 380, otherwise, the test returns an access-granted result, at 390. As noted above, the accumulated results may include more than a tally of the number of matches of the access-biometric to the protect-biometric, and a more comprehensive test may be performed at 370, in lieu of the example threshold-test.

As noted above, the parameters of the composite test, e.g. the threshold level at 370, can be selected to achieve a desired balance/trade-off between the probabilities of erroneously denying access at 380 to an authorized user and erroneously granting access at 390 to an unauthorized user, without being constrained by the probabilities of such errors at 330, in the comparator 240. One of ordinary skill in the art will be able to select a preferable threshold level, based on the probabilities p1 and p2, above, and N, the number of samples 180, to provide this trade-off, either algorithmically or heuristically. That is, if the independence of the individual comparison tests at 330 can be assured, and the probabilities p1 and p2 estimated, conventional statistical test procedures can be used to determine the number of non-matched comparisons required to deny access with a given level of confidence that an authorized user will not be denied access, and from that number of non-matched comparisons, determine the likelihood that an unauthorized user will be granted access. Alternatively, if the conditions and/or parameters for a formal statistical test-of-significance cannot be formulated, trial-and-error heuristic tests can be conducted to set the threshold parameters to achieve the desired tradeoff between wrongful-denials and wrongful-accesses.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the invention is presented in the context of providing a plurality of explicit samples 180 of an authorized user's biometric. One of ordinary skill in the art will recognize that, consistent with conventional statistical testing, the multiple samples 180 may be modeled by a representative sample and variances relative to that sample for each of the explicit samples of a user's biometric. In a general case, the multiple protect-samples 180 for comparing with the access-sample can be provided by statistical parameters derived from the plurality of samples 180, so that the access-sample can be compared to each of these samples 180 by comparing the access-sample to the statistical representation of the plurality of samples 180. These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements.

1. A method of protecting a protected object (170) comprising:
obtaining (230) a plurality of first samples (180) of a biometric of a user,
obtaining (220) a second sample (210) of the biometric,
comparing (240) the second sample (210) to the plurality of first samples (180) to provide a composite test result, and
granting access (250) to the protected object (170) based on the composite test result.

2. The method of claim 1, further including:
obtaining (220) at least a third sample of the biometric, and
comparing (240) the third sample to the plurality of first samples (180) to provide a second composite test result, and
wherein
granting access (250) to the protected object (170) is further based on the second composite test result.

3. The method of claim 2, wherein
the biometric includes one of:
a finger print,
a retina scan, and
a vocal cue.

4. The method of claim 1, wherein
obtaining the plurality of first samples (180) includes:
obtaining each sample (120) at substantially different times.

5. The method of claim 1, wherein
obtaining the plurality of first samples (180) includes:
obtaining at least one (120) of the first samples (180) coincident with a purchase of the protected object (170), and
obtaining at least one other (160) of the first samples (180) coincident with an other purchase of other objects.

6. The method of claim 1, further including
storing the plurality of first samples (180) of the user at a first location,
communicating the second sample (210) from a second location to the first location, and
communicating access authorization from the first location to the second location
wherein
granting access to the protected object (170) is based upon receipt of the access authorization at the second location.

7. The method of claim 6, wherein
communicating at least one of the second sample (210) and the access authorization includes communicating via an Internet connection.

8. The method of claim 1, wherein
obtaining the second sample (210) of the biometric includes verification that the sample is obtained directly from a living person.

9. A system comprising:
a receiver (230) that is configured to access a plurality of first samples (180) of a biometric associated with a protected object (170),
a reader (220) that is configured to provide a second sample (210) of the biometric,
a comparator (240) that is configured to compare the second sample (210) of the biometric to each of the plurality of first samples (180) of the biometric to provide a plurality of comparison results,
a tester (250) that is configured to provide an access authorization to the protected object (170) based on the plurality of comparison results.

10. The system of claim 9, further including:
a renderer (260) that is configured to render the protected object (170), based on the access authorization.

11. The system of claim 9, wherein
the reader (220) is further configured to provide other samples of the biometric,
the comparator (240) is further configured to compare the other samples of the biometric to each of the plurality of first samples (180) of the biometric to provide an other plurality of comparison results, and
the tester (250) is further configured to provide the access authorization based on the other plurality of comparison results.

12. The system of claim 9, further including:
a transaction device (150) that is configured to:
receive a purchase request (110) for the protected object (170), and
receive and store at least one sample (120) of the first samples (180) of the biometric associated with the protected object (170).

13. The system of claim 12, wherein
the transaction device (150) is further configured to:
identify a purchaser associated with the purchase request (110),
retrieve and store at least one other sample (160) of the first samples (180) of the biometric, based on other purchase requests by the purchaser.

14. The system of claim 9, wherein
the reader (220) is configured to provide the second sample (210) to the comparator (240) via an Internet connection, and
the tester (250) is further configured to communicate the access authorization via the Internet connection.

15. A system comprising:
a receiver (130) that is configured to receive:
a purchase request (110) from a purchaser for a protected object (170), and
at least one sample (120) of a biometric of the purchaser;
a security device (150) that is configured to provide the protected object (170), based on a plurality of samples (180) of the biometric of the purchaser, including the at least one sample (120) of the biometric from the receiver (130).
a transmitter that is configured to provide:
the protected object (170) and
the plurality of samples (180) of the biometric of the purchaser.

16. The system of claim 15, wherein
the security device (150) is further configured to create the plurality of samples (180) of the biometric to include one or more other samples (160) of the biometric associated with other purchase requests from the purchaser.

17. A data carrier (190) that includes:
a protected object (170), and
a plurality of samples (180) of a biometric of a purchaser of the protected object (170) that facilitate access to the protected object (170).
